(19) United States
(12) Patent Application Publication
(10) Pub. No.: US 2009/0083026 A1
(43) Pub. Date: Mar. 26, 2009

(54) Summarizing document with marked points

(75) Inventors: Ahmed Morsy, Bothell, WA (US); Kareem Mohamed Darwish, Cairo (EG)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/903,719

(22) Filed: Sep. 24, 2007

(51) Int. Cl. G06F 17/27; G06F 17/30

(52) U.S. Cl. 704/9; 707/3

(57) ABSTRACT

A summary of a text document may be presented in the form of a list of points. A summary of text can be created by choosing words or groups of words from the original text, by modifying words in the original text, etc. Collections of the chosen words can be presented in a list form together with a mark that indicates that the text is a list of words that might not form complete sentences. Presentation of a summary in list form may lower a reader's expectation as to readability issues such as sentence flow, word flow, etc., and thus the reader may be more accepting of a machine-generated summary presented in list form than of a machine generated summary presented as sentences or paragraphs.

### BACKGROUND

A text document can be summarized by a computer program. The process of creating a summary is generally performed by selecting particular sentences or phrases from the document based on how much information they convey, and including in this summary those sentences and/or phrases with the most information value. At present, people are better than machines at writing properly-flowing sentences and paragraphs. In order to retain a natural, human-written word flow, summarization techniques generally try to include large blocks of the original text, such as sentences or multi-word phrases. Attempts to put individual words together algorithmically often result in awkward sentences that do not sound like they were written by a person.

Retaining large blocks of text in a summary retains a natural-seeming flow of words but also increases the length of the summary, since some words are retained to convey the original word flow rather than to convey information. If a reader read the summary with lower expectations of language quality, a more condensed summary could be provided based on smaller groups of words, or individual words, chosen from the individual text.

Summarization of text can be used in search results. Cross-language search results (results obtained by using a query in one language to search material in another language) can produce summaries of particularly low quality, because the combination of summarization and translation can produce an unnatural-sounding word flow.

### SUMMARY

A text can be summarized by creating a list of points based on words and/or phrases from the text. Words or phrases may be chosen for the points based on the amount of information that the words or phrases convey. Presenting the words or phrases in the form of a list of points (e.g., bullet points, numbered points, etc.) tends to lower a reader's expectation of sentence flow, and allows words or phrases to be chosen based on how much information they convey with relatively little regard to how well the words flow, or how much they sound like human-written text.

Translated documents can be summarized in the form of a list of points. The combination of software-directed translation and summarization can produce an awkwardly-worded document. A list of points can be used to present a summary of translated material. Since a reader may have a relatively low expectation as to the flow of words in such a list, the reader may perceive a list of points as being of higher quality than summary of a translated text that is presented in the form of sentences and/or paragraphs. In a cross-language search, summaries of the search results can be presented in the form of a list of points, and the words in the search query can be used to constrain the translation of the results documents back into the language of the query. However, the subject matter described herein is not limited to translated documents or cross-language search, but rather may be used in any context or scenario.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of text, and of a list of points into which the text may be converted.

FIG. 2 is an example of the text of FIG. 1, broken down by words, phrases, and sentences.

FIG. 3 is a flow diagram of an example method of creating points in one language of a document that exists in another language.

FIG. 4 is a flow diagram of an example method of using a query in one language to search material that exists in another language

FIG. 5 is a diagram of example techniques that create points.

FIG. 6 is a block diagram of example components that may be used with implementations of the subject matter described herein.

### DETAILED DESCRIPTION

Text can be summarized by software-driven techniques such as choosing sentences, or phrases within sentences, and presenting this chosen phrases or sentences as part of a summary. However, when text is summarized in this manner by a software-driven process, the resulting summary may appear to have an awkward and choppy writing style. Such content, when presented to a person in the form of sentences and paragraphs, can generally be recognized by a human reader as machine-generated content. However, presenting summarized content in the form of a list of points (e.g., bullet points, enumerated points, etc.) tends to lower the reader's expectations of word and sentence flow, and may increase the reader's perception of the same content.

Summarization and language translation are two areas that can be performed by software-driven processes, but that tend to produce awkward text that does not flow in the same way as text written by a person. When summarization and language translation are combined—a process sometimes referred to as cross-language summarization—each of these processes can interact with the other in a way that either masks, or exacerbates, the flaw of the other. The result of this combination could be particularly awkward text. When a document is translated and summarized, presenting the summary in the form of a list of points may increase the reader's perception of the document.

A scenario in which cross-language summary may be performed is in the case of a cross-language query—a query written in one language to search material written in another language. When such a query is available, the translation process can make use of the query by using the query terms to constrain the translation. For example, if a term in the source language of the query is “delicious,” and the search results contain a word in a target language that can be translated back to the source language as either “tasty” or “delicious,” then the translation process can choose the word “delicious” based on the appearance of that word in the query. When the query is used to constrain the translation in this manner, the reader may recognize his or her query term in the summarized results, which can increase the reader's perception of the results. A reader may be relatively accepting of a software-driven summary and translation that is presented in the form of a list of points, and for which the translation is query constrained. However, the subject matter herein is not limited to this scenario.

Referring now to the drawings, FIG. 1 shows an example of text that is converted to a list of points. Text 102 may take the form of a paragraph organized into sentences 104, 106, and 108. Text 102 may be converted to a list 110 of one or more points 126, 130, 132, and 134. List 110 of points may capture information contained in text 102, but the points may present this information in way that might be shorter or more compact than text 102, and may lack the sentence flow of text 102.

List 110 of points may be created by taking some words and/or phrases from text 102 and omitting others, and putting these words and/or phrases together in the form of summaries. For example, sentence 104 of text 102 contains phrase 112 (“search technology”) word 114 (“has”), word 116 (“dramatically”), word 118 (“increased”), word 120 (“access”), word 122 (“to”), and word 124 (“information”). Two or more words can be treated as individual words, or can be treated as one phrase. In the example of FIG. 1, “search” and “technology” are treated together as a phrase, although these words could also be treated as the individual words “search” and “technology.” Groups of two or more words that have a particular meaning when put together may be recognized as such. Recognizing when two or more words form a phrase may assist the process of accurately summarizing text in the form of points, although points can also be created from individual words.

Summary point 126 contains some of the words and phrases from sentence 104 and/or modified versions thereof. In particular, summary point 126 contains phrase 112, and words 128, 120, 122, and 124. These words and phrases may have been selected from sentence 104 based on an assessment that these words can convey information from sentence 104 even if other words in that sentence are omitted. In this example, phrase 112 and words 120, 122, and 124 were taken directly from sentence 104, while word 128 (“increases”) is a modified version of the word 118 (“increased”) that appeared in sentence 104. A process of creating points may choose to convert verbs to the present tense, as in this example, although the original form of a verb could also be used. Additionally, in this example the words appear in summary point 126 in the same order as they appear in sentence 104 (with some words omitted), although the process of creating summary point 126 from an original sentence could rearrange the words to an order that differs from their original order.

Points 130, 132, and 134 summarize other parts of text 102. For example, summary point 130 summarizes the latter part of sentence 104, and points 132 and 134 summarize portions of sentence 106. In list 110 of points, each summary point summarizes a portion of a sentence in text 102, although a summary point could also be created that summarizes a whole sentence, or more than one sentence. Additionally, it may be the case that some sentences are not selected to be summarized in a summary point—e.g., in FIG. 1, text 102 contains sentence 108, which is not the subject of a summary point in list 110.

Points 126, 130, 132, and 134 are each introduced by a mark 136. The presence of mark 136 may indicate or signal to a reader that the text contained in points is a non-sentence, or something other than a complete sentence. In the example of FIG. 1, mark 136 is a bullet, which is a mark that is often used in text to separate summary point. However, mark 136 could be any type of mark, such as a dash, an asterisk, a numbered (as in the case where points appear in a numbered list), or any other type of mark. Moreover, mark 136 can be a written symbol, as shown in FIG. 1, but could also take any other forms, such as an audible form. For example, points could be rendered by a text-to-speech system, or could be read by a person, in which case each summary point could be preceded by a “ding” or other tone to introduce the point. In such an example, mark 136 could be the “ding” or tone. A version of mark 136 can be created for any form of communication, whether written, audible, tactile (e.g., Braille), visual (e.g., hand signals), etc.

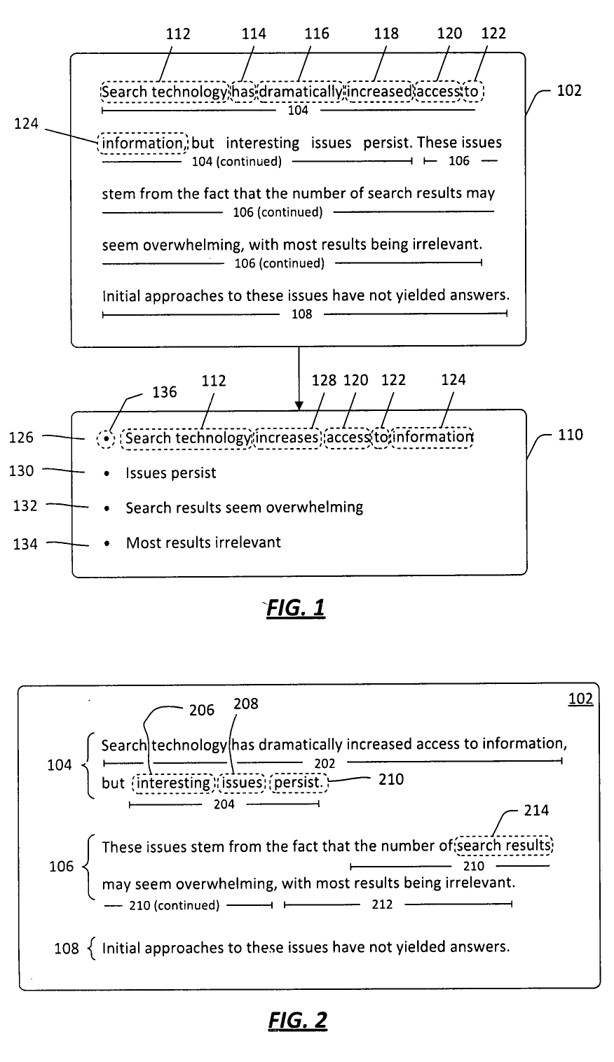

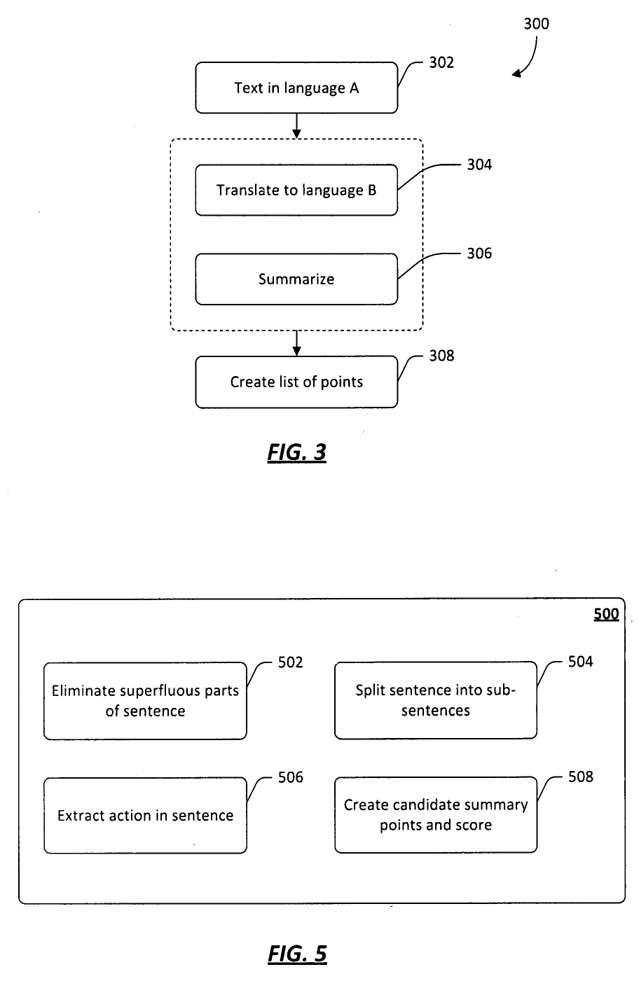

Points 126, 130, 132, and 134 are created by removing words and/or phrases from text 102, and/or by altering the words or phrases in text 102. FIG. 2 shows text 102 broken down by words, phrases, and sentences.

In FIG. 2, text 102 comprises sentences 104, 106, and 108 (as in FIG. 1). Sentences 104, 106 and 108 can be viewed as being made up of words and phrases. Summarization and sentence reduction technology often divides up text into large groups of words—e.g., whole sentences, or phrases made up of several words in sequence—and attempts to determine whether these groups of words are to be included in, or omitted from, the summary. Since the resulting summary is often presented in the form of textual sentences or paragraphs, summarization technology often focuses on maintaining the flow of sentences or words, as they would have been put together by a person. Thus, such technologies often try to maintain large blocks of words in the original text together, since these blocks retain the flow of human-written text. Since the reader's expectation of the writing quality of points may be lower than it would be for ordinary text, it is possible to create points without regard, or with less regard, for sentence flow or word flow than would apply if ordinary text were being created. To the extent that operating on large blocks of text is intended to retain the flow that was created by a person, creation of points can operate on smaller blocks of text—or individual words—and thus can focus more on conveying the original meaning and less on maintaining the flow of words and sentences. Thus, FIG. 2 shows how the text 102 can be broken up into blocks of different sizes.

In FIG. 2, sentence 104 can be viewed as including phrases 202 and 204. Phrases 202 and 204 can be identified, for example, based on the fact that each contains a subject and a predicate. The combination of a subject and a predicate may suggest that each of phrases 202 and 204 could be presented on its own, and would sound like human-written text, even if the other phrase were not present. In the process of identifying such phrases, certain words may be omitted. For example, in sentence 104, the word “but” is acting as a connector between two portions of a compound sentence. If either of phrases 202 or 204, were presented on its own, then “but” would not be used to connect anything, so it is not logically part of either phrase.

Beyond phrases 202 and 204, it is possible to break down sentence 104 even further. For example, phrase 204 (“interesting issues persist”) can be broken down into its individual words 206, 208, and 210. If sentence 104 were being processed to create a textual summarization, it might not be appropriate to consider retaining or omitting individual words 206, 208, and/or 210, since omitting individual words runs the risk of disturbing the human-created flow of the text. However, if points are to be created, from sentence 104, there is less reason to be concerned with the flow of the text, so individual words 206, 208, and/or 210 can be omitted or letained based, for example, on whether they help to convey the meaning of sentence 104, or a portion thereof. For example, in order to convey meaning, it might be relevant to note that “issues persist,” but the modifier “interesting” might be considered expendable in summarizing the concept. Thus, in one example, a summary point based on sentence 104 might contain words 208 and 210, but not word 206.

Sentence 106 may be viewed as including phrases 210 and 212. Phrase 210 is a phrase that includes a subject and a predicate. For reasons similar to those discussed above, it may be determined that, if maintenance of human-created sentence flow is to be taken into account, then phrase 210 can stand on its own. Phrase 212 (“most results being irrelevant”) is not quite able to stand on its own as a sentence, but could be converted to a sentence by changing the verbal form “being” to “are”.

Phrases 210 and 212 each present choices as to how they are to be summarized. For example, the subject in phrase 210 is “the number of search results,” and thus if the human-written flow is to be retained, then the safe choice is to retain the phrase with this subject. However, a further analysis of the phrase could reveal that “search results” (sub-phrase 214) carries more meaning than “the number”, and thus the sub-phrase “search results” can be retained while omitting “the number.” Similarly, the word “may” may not convey much information relative to the other parts of phrase 210, so that phase could be summarized as “search results seem overwhelming”. In phrase 212, the original wording (“most results being irrelevant”) is not a complete sentence, so a system that seeks to retain original combinations of words might either omit phrase 212 (thereby losing its meaning), or retain it as a whole along with the rest of the sentence (thereby retaining the original flow of words, but not reducing the sentence as much as it could be reduced). However, if retaining human-written word flow is not a concern, or is a lesser concern, then phrase 212 can be included in a summary as-is (without concern as to whether it is a complete sentence), or modifications can be made (e.g., changing “being” to “are”) with relatively little concern for whether the original human-written sentence flow is being retained.

Providing search results and cross-language summarization are areas in which the process of generating points from text may be used. In a page of search results, each document in the results list is often provided along with a highlight phrase, which is taken from the document and contains one or more of the search terms. Points could be provided instead of (or in addition to) the highlight phrase. Since the points could be created with less regard to retaining original word flow than the highlight phrase, the points may convey more information.

Cross-language summarization (i.e., taking a text in one language and summarizing it in another language) is another area in which points can be used. Machine translation of text often produces results that sound unnatural in the target language. Summarization in conjunction removes portions of the translated text (or may remove portions of the original text, depending on the order in which summarization and translation are done), so the combination of summarization and translation processes may allow one process either to mask, or to exacerbate, the other's weaknesses. Since a reader may have lower expectations for the quality of points than for text, providing results of cross-language summarization in the form of a set of points may enhance a reader's perception of a cross-language summary.

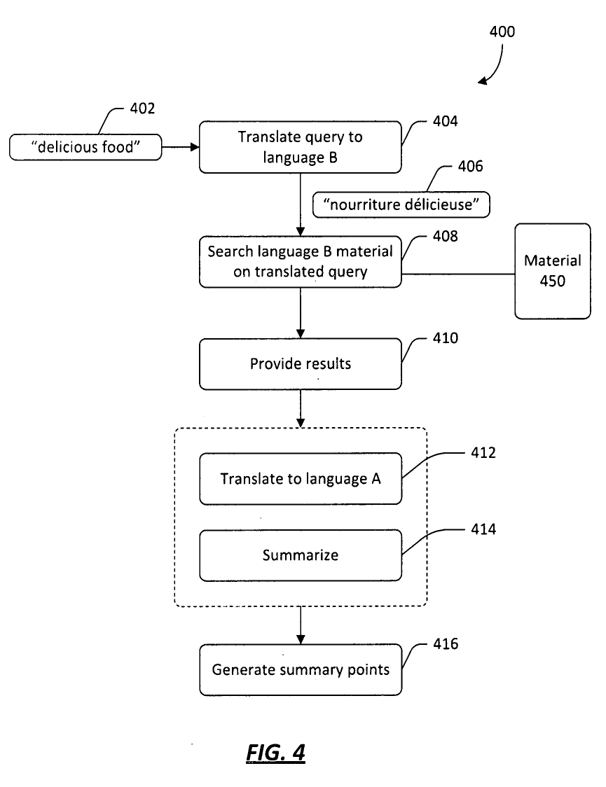

Before turning to a discussion of FIGS. 3 and 4, it is noted that the flow diagrams in each of these figures show examples in which stages of processes are carried out in a particular order, as indicated by the lines connecting the blocks, but the various stages shown in these diagrams can be performed in any order, or in any combination or sub-combination.

Turning now to FIG. 3, there is shown a method 300 of creating points in language B for a text 302 that exists in language A. At 304, text 302 is translated from language A into language B. At 306, the translated text is summarized, such as by removing sentences or phrases from the translated text. 304 and 306 are shown enclosed within a dashed box, indicating that these stages (like other stages shown in the diagrams) can be performed in any order. That is, text 302 could be translated from language A into language B and then summarized, or text 302 could be summarized in language A, and then the summary could be translated into language B. The choice of what order to perform these stages in could be based on the identities of the language pair (e.g.; the choice of order could be different for French-to-English than for Japanese-to-Farsi), the direction of translation (e.g., the choice of order could be different for English-to-French than for French-to-English), or the particular tools involved (certain combinations of summarization and translation tools might work better with each other in a particular order). After the summary/translation is performed, points (such as list 110 of points 126, 130, 132, and 134, shown in FIG. 1), are created (at 308). The points can then be communicated (e.g., over a network), or displayed (e.g., on a display).

Combining search results with cross-language summarization is yet another area in which points can be used. A query in a source language can be used to search material in target language. The results can be obtained by translating the words in the query from the source language to the target language, and then carrying out the translated query on material in the target language. The results (e.g., an identification of one or more documents that satisfy the query) can be provided in the source language, along with a highlight phrase from each document in the result. Source-language words from the query can be used to constrain translation from the target language back into the source language. The highlight phrase is generated either by summarizing the document in its native language and translating the summary into the source language, or by translating the document from its native language into the source and then summarizing the translation. Instead of (or in addition to) providing a highlight phrase, a set of points can be generated and provided.

FIG. 4 shows a method 400 of using a query 402 in language A to search material that exists in language B. In the example of FIG. 4, language A is English and language B is French, although any pair of languages can be used. Query 402 is received and translated (at 404) to language B, resulting in query 406. Material 450 in language B is searched (at 408) using translated query 406. The search may be performed, for example, by a search engine. At 410, results based on the query are provided. At 412 and 414, the results are translated and summarized. As discussed above in connection with FIG. 3, summarization and translation can occur in any order—either by translating results from language B to language A and then summarizing the translation, or by summarizing the results in language B and translating the summary. The considerations discussed in connection with FIG. 3 for deciding which stage to perform first can be applied to FIG. 4 as well. Query 402 may be used as part of the translation. For example, if the results provided at 410 include a word in French that can be translated into English as either “tasty” or “delicious,” when query 402 is consulted it can be seen that the query used the word “delicious,” and thus the translation of the word back into English may favor using the word “delicious” instead of “tasty.” This use of the original query as part of the translation process is often referred to as “query-constrained translation.” At 416, points are generated based on the translated and summarized query results. Using a query-constrained translation of the language B material as input to the generation of summary point can result in points that are easily recognizable by the user as being responsive to the query.

While FIG. 4 shows an example in which the query is translated from language A to language B in order to search source material in language B, it should be noted that a cross-language search can also be performed by translating the language B material into language A and then searching on the translated material using the language A query. In this case, the material that is found to satisfy the query can be summarized without an additional translation stage, since that material would already have been translated. As another example, the query and the material to be search can each be translated into an intermediate language, and the query can be used to search the material in that intermediate language.

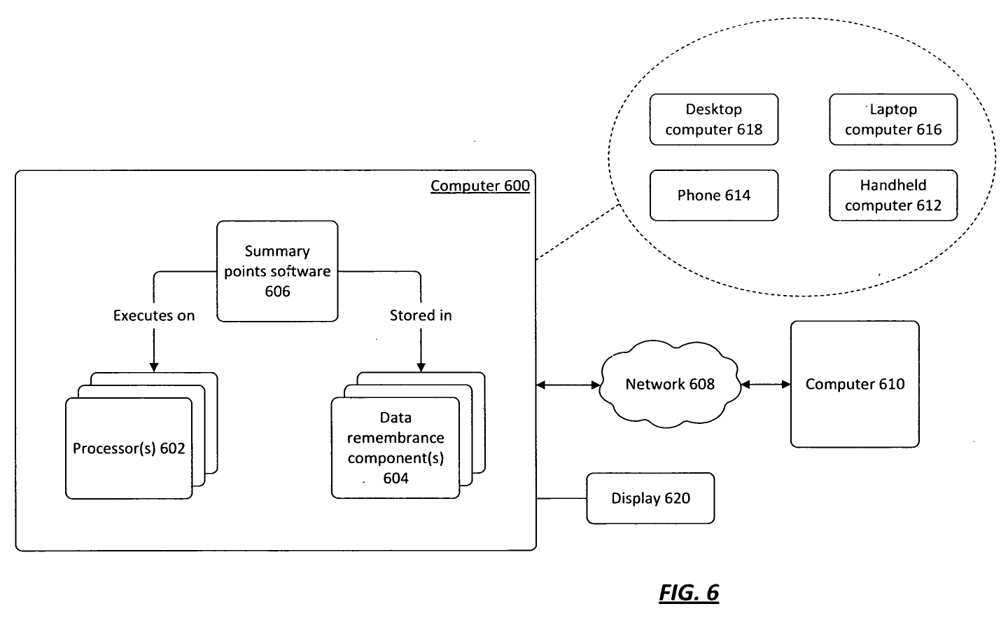

The generation of points can be performed using various techniques. FIG. 5 shows various stages that may be used as part of a method 500 to generate points. These stages can be performed in any order, and in any combination or sub-combination.

One stage 502 that can be performed is to eliminate superfluous parts of a sentence. For example, suppose that a text contains the sentence, “Despite the difficulty of summarization, the system seeks to produce a bullet point presenting the content of the sentence.” The phrases “despite the difficulty of summarization” and “the system seeks to” could be found to be superfluous to the content of the sentence, so a summary point based on the sentence might be: “Produce a bullet point presenting the content of the sentence.”

Another stage 504 that can be performed is to split a sentence into sub-sentences. For example, the sentence, “I went home, and then I ate,” is a compound sentence that can be split into two subject-predicate parts: (1) “I went home”; and (2) “I ate”. Each of these parts could then be presented as a summary point.

Another stage 506 that can be performed is to extract the action from a sentence. In the example sentence discussed above (“Despite the difficulty of summarization, the system seeks to produce a bullet point presenting the content of the sentence”), there are two verbs in the sentence (“seeks” and “produce”). It could be determined that “produce” in this context is associated with more action than “seeks,” so the concentration of action in the sentence could be understood as “produce a bullet point,” and this latter portion of the sentence could be presented as a summary point.

Another stage 508 that can be performed is to generate a plurality of candidate points from a text based on a variety of techniques (e.g., the techniques shown at stages 502-506, or other techniques), and then to assign score the points and choose one or more points based on score. For example, one hundred candidate combinations of words could be generated based on the same sentence and scored based on one or more criteria. Then, one point (or two, or three, etc.) could be chosen from among the candidates based on score. The scores could be generated in any manner based on any type of criteria. A score could be a one-dimensional quantity (e.g., a single number), a multi-dimensional vector (e.g., an n-tuple of quantities), or could take any form. Examples of scoring criteria include: analysis of the likelihood that the candidate is to appear in a human-generated sentence; analysis of how well the candidate captures the information in the original sentence; a comparison between the text and a query (if the text to be summarized is a search result). Any combination of these factors, or other factors, can be used. A set of candidates can be generated based on a particular sentence in a text, or can be generated based on the whole text, or on any portion of the text.

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are devices that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 620, which may be a cathode ray tube (CRT) monitor, a liquid crystal display (LCD) monitor, or any other type of monitor.

Computer 600 may take the form of any type of computing device. Handheld computer 612, phone 614, laptop computer 616, and desktop computer 618 are examples of computer 600, although computer 600 could take the form of any type of machine that has some computational and/or data handling capability. It is noted that the points described herein may condense information, which may make the information easily viewable on a small screen, such as that of handheld computer 612 or phone 614, although the points can be displayed on any type of machine.

Software may be stored in the data remembrance component(s) 604, and may execute on the one or more processor(s) 602. An example of such software is points software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A machine (such as desktop computer 618, laptop computer 616, handheld computer 612, or phone 614) in which a program is stored on a hard disk or other device, loaded into RAM, and executed on the machine's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as software having instructions to perform one or more acts, where the instructions are stored on one or more computer-readable storage media.

In one example environment, computer 600 may be communicatively connected to one or more other devices through network 608. Computer 610, which may be similar in structure to computer 600, is an example of a device that can be connected to computer 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media comprising executable instructions to perform a method comprising:
selecting, from a document that comprises a plurality of words organized into one or more sentences, one or more of said words based on an assessment of how well said words convey information contained in said document;
generating one or more points based on said one or more words; and
communicating or displaying each of said one or more points with a mark that signals presence of content that is other than a complete sentence.

2. The one or more computer-readable storage media of claim 1, wherein said one or more points are in a first language, and wherein the method further comprises at least one of:
translating a source in a second language into said first language to create said document; and
translating said one or more words from said second language into said first language, wherein said document is in said second language.

3. The one or more computer-readable storage media of claim 1, wherein said one or more points are in a first language, wherein said document is in a second language, and wherein the method further comprises:
determining whether to translate said document prior to said selecting, or to translate said one or more words after said selecting, based on identities of said first language and said second language.

4. The one or more computer-readable storage media of claim 1, further comprising:
receiving a query in a first language;
identifying said document based on said query, wherein said document is in a second language;
translating, from said second language into said first language, either: (a) said document prior to said selecting, or (b) said one or more words after said selecting, wherein said translating uses one or more terms from said query to constrain a translation from said first language to said second language.

5. The one or more computer-readable storage media of claim 1, wherein said mark comprises a bullet.

6. The one or more computer-readable storage media of claim 1, wherein said generating comprises:
creating a plurality of first points, said one or more points being included in said plurality of first points;
assigning scores to said plurality of first points; and
selecting said one or more points from among said plurality of points based on said scores.

7. A method of providing results of a search, the method comprising:
receiving a query;
first selecting of one or more documents based on said query, wherein each of said documents comprises a plurality of words organized into one or more sentences;
second selecting, from a first one of said one or more documents, one or more words based on a first assessment of how well said one or more words convey information contained in said first one of said one or more documents;
creating one or more points, wherein each of said points comprises at least some of said one or more words and a mark; and
communicating or displaying an identification of said first document together with said one or more points.

8. The method of claim 7, wherein the query is in a first language, wherein the one or more points are in a second language, and wherein the method further comprises:
performing a translation from said first language to a second language, wherein said translation is constrained by one or more terms in said query, and wherein said translation is either: (a) performed on said document prior to said second selecting, or (b) performed on said one or more words after said second selecting.

9. The method of claim 8, further comprising:
choosing between (a) and (b) based on at least one of:
identities of said first language and said second language;
a direction of said translation; and
a tool that is used to perform said translation.

10. The method of claim 7, wherein said creating comprises:
creating a plurality of first points, said one or more points being included in said plurality of first points;
assigning scores to each of said plurality of first points; and
choosing said one or more points from among said first points based on said score.

11. The method of claim 10, wherein said scores are based on a comparison of said query with each of said plurality of first points.

12. The method of claim 10, wherein said scores are based on a second assessment of a likelihood of each of said plurality of first points' appearing in a sentence in a language in which said query is written.

13. A system comprising:
one or more processors;
software that executes on at least one of said one or more processors and that is stored in one or more data remembrance components, that obtains content that comprises one or more sentences, that selects one or more words from said one or more sentences, or from a translation of said sentences, based on a first assessment of how well said one or more words convey information in said one or more sentences, that generates one or more points that contain said one or more words, and that communicates or displays said one or more points.

14. The system of claim 13, wherein said software presents said points in a first language, wherein said content is obtained in a second language, and wherein said software performs said translation either by translating said sentences from said second language to said first language prior to selecting said one or more words, or by translating said one or more words from said second language to said first language after said one or more words have been selected.

15. The system of claim 14, wherein said software processes a query that comprises one or more terms in said first language, wherein said content comprises results to said query that are in said second language, and wherein at least one of said one or more terms is used to constrain said translation.

16. The system of claim 13, wherein said software generates a plurality of first points, said one or more points being included in said plurality of first points, wherein said software assigns scores to said plurality of first points and generates said one or more points by selecting said one or more points from among said plurality of first points based on said scores.

17. The system of claim 13, wherein said software uses a query that comprises one or more terms in a first language to search said content in said first language, said content comprising material that satisfies said query and that has been translated from a second language to said first language prior to being compared to said one or more terms.

18. The system of claim 13, wherein said software selects said one or more words based on a second assessment that said one or more words convey an action in at least one of said one or more sentences.

19. The system of claim 13, wherein said software selects said one or more words based on a second assessment that said one or more words convey more of said information than do portions of said one or more sentences other than said one or more words.

20. The system of claim 13, wherein at least one of said one or more sentences is a compound sentence, and wherein said software generates said one or more points based, at least in part, on a split of said compound sentence into two or more sub-sentences.
